(19) United States
(12) Patent Application Publication
(10) Pub. No.: US 2006/0291189 A1
(43) Pub. Date: Dec. 28, 2006

(54) Power amplifier having light-up handles

(76) Inventor: Hersel Mahgerefteh, Vernon, CA (US)

Correspondence Address: MORLAND C FISCHER, 2030 MAIN ST, SUITE 1050, IRVINE, CA, 92614, US

(21) Appl. No.: 11/167,016

(22) Filed: Jun. 24, 2005

(51) Int. Cl. F21V 33/00

(52) U.S. Cl. 362/86; 362/555

(57) ABSTRACT

A power amplifier of the kind adapted to drive a speaker of a sound system and having a light-up handle at each of the opposite sides thereof. Each light-up handle is preferably a rod or cylinder that is manufactured from a light transmitting plastic (e.g., acrylic) material. A plurality of light reflective bubbles are randomly distributed in the plastic material to enhance the visual effect produced by the light-up handles. Each end of each handle has a cavity formed therein. An LED is located within each cavity so that a pair of LEDs at opposite ends of a handle will face one another in spaced axial alignment. The LEDs are energized by a DC voltage so as to inject beams of light longitudinally through the handles from opposite ends thereof. Accordingly, the handles will be illuminated to produce an ornamental, aesthetically pleasing neon light effect that will be visible to onlookers through the light transmitting material of the handles.

### BACKGROUND OF THE INVENTION

1. Field of the Invention

This invention relates to a power amplifier for driving one or more speakers of a sound system and having a pair of light transmitting handles to which a lifting force is applied to relocate the power amplifier. Light emitting diodes are located at opposite sides of the handles to inject light beams longitudinally therethrough, whereby the handles will be illuminated in order to create a decorative neon light effect.

2. Background Art

Power amplifiers are well known electronic devices for driving one or more speakers of a sound system from which sound is emitted. Such amplifiers are typically unattractive box-like devices that may be arranged in a stack with other audio electronic devices. Should the power amplifier need to be carried from one place to another, it is simply grasped and lifted.

Accordingly, it would be desirable to provide the power amplifier with a decorative, aesthetically pleasing feature that will be visible to onlookers, particularly in low light environments. It would also be desirable to provide the power amplifier with a pair of handles by which to facilitate the amplifier being lifted and relocated from one place to another. It would still be further desirable to accomplish both objectives by providing the power amplifier with a pair of light-up handles that are capable of being illuminated by a readily available low power light source.

### SUMMARY OF THE INVENTION

In general terms, a power amplifier is disclosed having conventional electronics for driving one or more speakers of a sound system. The electronics of the power amplifier are enclosed by a metallic casing. Pairs of handle supports project outwardly from opposite sides of the casing. A light-up handle extends between each pair of handle supports. A gap is established between the handle and a side of the casing in which to receive the fingers of a user when it is necessary to grasp the handle in order to lift the amplifier. Each handle preferably has a cylindrical or tubular shape and is molded from a suitable plastic (e.g., acrylic) material that is adapted to transmit light therethrough. The light being transmitted through the handle will be visible to onlookers to create an aesthetically pleasing and ornamental neon light effect. To enhance the neon light effect, a plurality of light reflecting bubbles are distributed throughout the handle during molding.

A cavity is formed in each of the opposite ends of the handles carried by the pairs of handle supports. A commercially available (e.g., 3 volt DC) light emitting diode (LED) is located in each cavity such that a pair of LEDs face one another in spaced axial alignment. Pairs of wires run through each of the handle supports to provide DC power to the LED at respective ends of the handles. When the LEDs are energized, light beams are injected from opposite ends of the handles to be transmitted longitudinally therethrough. Accordingly, the handles will be illuminated so as to appear to light-up and thereby improve the ornamentality of the power amplifier.

### BRIEF DESCRIPTION OF THE DRAWINGS

FIG. 1 is a perspective view of a power amplifier having a pair of light-up handles according to the preferred embodiment of this invention running along opposite sides of the amplifier to produce an ornamental neon light effect;

FIG. 2 is a partial top view showing one of the pair of light-up handles extending between a pair of handle supports at one side of the power amplifier of FIG. 1;

FIG. 3 is another partial top view, but with one of the pair of handle supports removed so as to show light emitting diodes located in cavities at opposite ends of the handle;

FIG. 4 shows a cross-section of a handle support taken along lines 4-4 of FIG. 2; and

FIG. 5 shows a cross-section of the same handle support taken along lines 5-5 of FIG. 2.

### DESCRIPTION OF THE PREFERRED EMBODIMENT

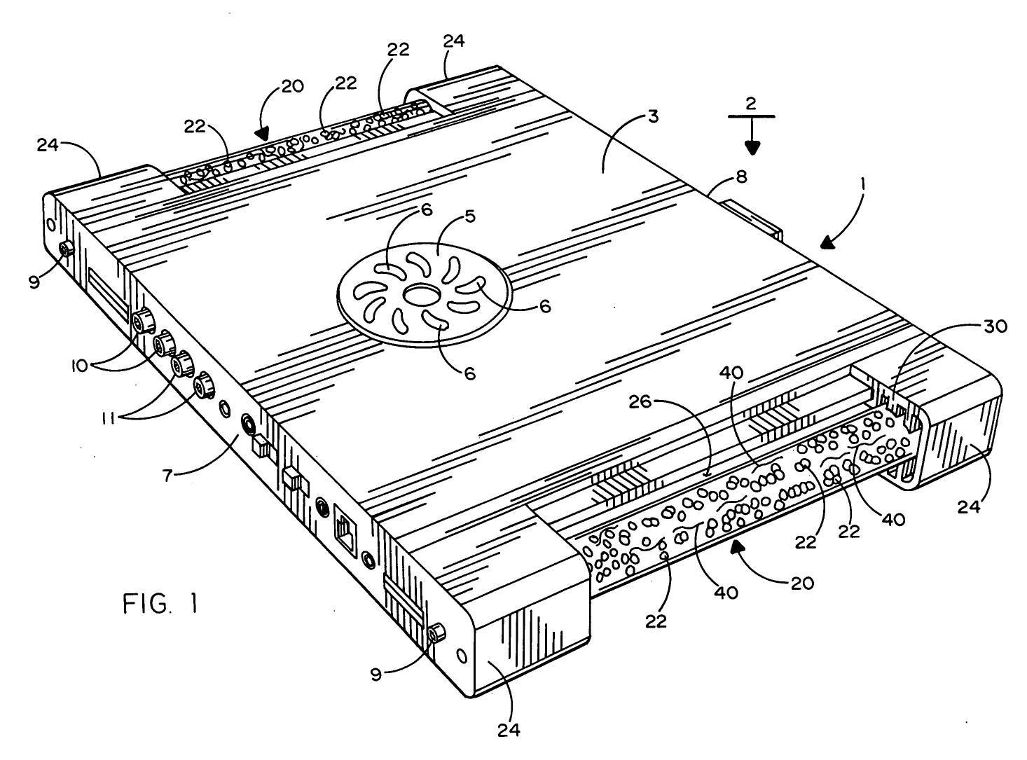

The power amplifier 1 and the light-up handles 20 thereof according to the preferred embodiment of this invention are initially described while referring to FIG. 1 of the drawings. The function of power amplifier 1 for driving one or more speakers of a sound system is conventional and, therefore, will not be described herein. To this end, power amplifier 1 includes an outer casing or housing 3 that encloses the electronics that are common to a conventional power amplifier. Casing 3 is typically manufactured from a metallic material, such as aluminum, or the like. A fan cover 5 having openings 6 formed therein is mounted at the top of casing 3 to provide an exhaust for warm air that is blown to the atmosphere by a fan (not shown) at the interior of amplifier 1. The casing 3 includes removable front and rear panels 7 and 8 that are held in place by fasteners 9. Input terminals 10 and output terminals 11 are accessible at the front panel 7 of casing 3. A set of DC power terminals and a set of output speaker terminals (not shown) are located at the rear panel 8 of casing 3.

In accordance with the present improvement, a pair of identical light-up handles 20 are located in spaced parallel alignment with opposite sides of the power amplifier 1. Each handle 20 is preferably a solid elongated cylinder or rod that is molded from a suitable plastic material, such as acrylic, that is adapted to transmit light therethrough. To create multiple reflections and thereby enhance the soon-to-be-described visual effect, the handles 20 are molded with a plurality of light reflecting bubbles 22 randomly distributed along the length thereof. Although the handles 20 are shown herein as having a cylindrical cross-section, handles having other cross-sections (e.g., square, rectangular, hexagonal, etc.) may also be adopted without departing from the scope of this improvement.

The light-up handles 20 of power amplifier 1 are supported by respective pairs of handle supports 24 that project outwardly from the opposite sides of the casing 3. Each handle 20 runs between a pair of handle supports 24 so as to be spaced from the casing 3 by a small gap 26 which is sized to receive the fingers of a user therein. Hence, when it is desirable to lift the audio amplifier 1 to be relocated from place to place, a user simply and conveniently wraps his hands around the handles 20 along the sides of amplifier 1 so that his fingers extend through the gaps 26.

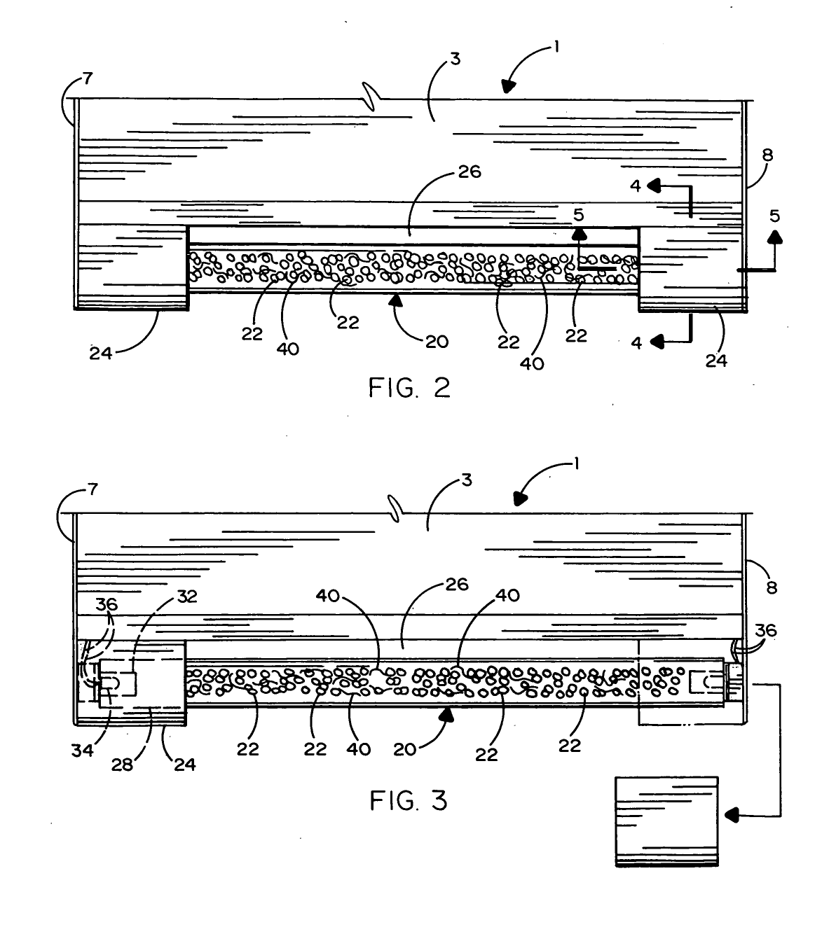

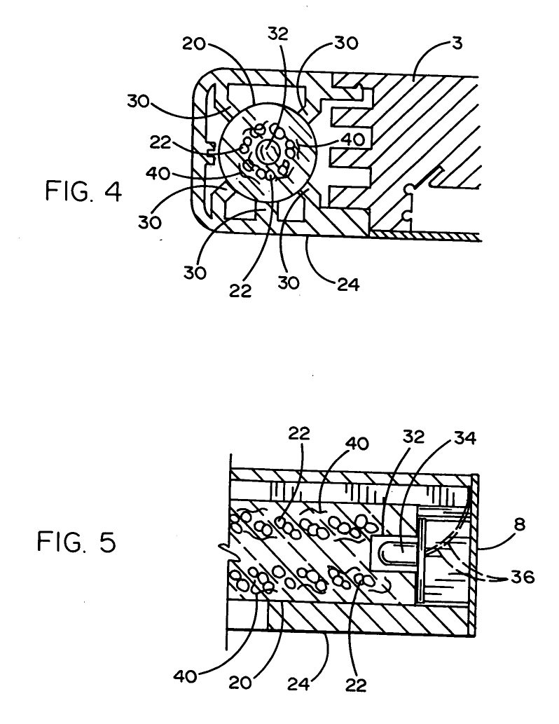

The light-up visual effect produced by handles 20 is now described while referring concurrently to FIGS. 2-5 of the drawings, where a single one of the pair of handles 20 is shown supported at the opposite ends thereof by respective handle supports 24. Each handle support 24 has an evacuated area (designated 28 and best shown in FIG. 3). The evacuated area 28 of each handle support 24 is sized to accommodate therein a corresponding end of a light-up handle 20. The handles 20 are positioned in the evacuated areas 28 of handle supports 24 after one of the front or back panels 7 or 8 is first removed from the casing 3. As is best shown in FIG. 4, the end of each light-up handle 20 that is received within the evacuated area 28 of a handle support 24 is engaged and retained by a series of finger-like projections 30.

Each end of a light-up handle 20 has a short, axially extending cavity 32 (best shown in FIG. 5) formed therein. The cavity 32 is sized to receive therein a commercially available light emitting diode (LED) 34. Thus, in the assembled configuration shown in FIG. 3, a pair of light emitting diodes 34 at opposite ends of a handle 20 will face one another in spaced axial alignment. By way of example only, one suitable LED for use herein is a 3 volt DC device that is manufactured under Part No. PLC013-02 by a variety of manufacturers. A pair of wires 36 is connected to each LED 34 through a handle support 24 by which DC power is provided to energize the LED 34. In this same regard, the LEDs 34 can be selected to generate a colored (e.g., blue) light.

Therefore, it may be appreciated that when the pair of LEDs 34 at opposite ends of a handle 20 are illuminated, opposite beams of light will be injected longitudinally therethrough whereby to cause the handle to appear to light up. Such light will be visible to onlookers through the plastic material from which the handle 20 is molded. By virtue of the light reflective bubbles 22 that are distributed along the handle 20, the visual effect produced by the LEDs 34 will be enhanced. To further enhance this visual effect, a colored dye (designated 40 in FIG. 1) can be mixed into the plastic material prior to its being molded to form the cylindrical handle 20. In this case, the handle 20 will have a colored hue corresponding to the color of the dye when the LEDs 34 are illuminated.

Once the power amplifier 1 is powered up, the LEDs 34 will be energized so that the pair of handles 20 carried by respective pairs of handle support 24 at the opposite sides of the amplifier 1 will produce an ornamental neon light effect. Such a neon light effect will improve the aesthetic appeal of the amplifier, especially in environments where little or no light is present.

I claim:

1. An amplifier to drive a speaker, said amplifier including at least one handle to which a lifting force is applied, said handle being manufactured from a light transmitting material and having a longitudinally extending cavity formed therein; and
a source of light located within said cavity and axially aligned with said at least one handle to inject a longitudinally extending beam of light into said handle whereby to cause said handle to be illuminated and visible to onlookers.

2. The amplifier recited in claim 1, wherein said at least one handle is manufactured from a plastic material.

3. The amplifier recited in claim 2, wherein the plastic material of said at least one handle includes a colored dye.

4. The amplifier recited in claim 1, wherein said at least one handle has a plurality of light reflective bubbles therein to reflect the beam of light that is injected by said light source.

5. The amplifier recited in claim 1, wherein said light source is a light emitting diode.

6. (canceled)

7. The amplifier recited in claim 5, wherein said light emitting diode emits a colored beam of light to be injected into said at least one handle.

8. A power amplifier to drive a speaker, said power amplifier having a casing including a front, a back, and a pair of sides, a fan opening formed in said casing through which fan air is blown for cooling said power amplifier, a pair of light transmitting handles running along the outside of said casing to which a lifting force is applied, and a source of light aligned with each of said pair of handles to inject beams of light longitudinally into said pair of handles to cause said handles to be illuminated and visible to onlookers.

9. The power amplifier recited in claim 8, wherein said source of light is a light emitting diode.

10. The power amplifier recited in claim 9, wherein each end of each one of said pair of handles has a cavity formed therein, a light emitting diode located within said cavity so that a pair of light emitting diodes at opposite ends of each handle are arranged to face one another in spaced axial alignment.

11. The power amplifier recited in claim 9, wherein each of said pair of handles includes a plurality of light reflective bubbles distributed within the light transmitting material thereof.
